(19) United States
(12) Patent Application Publication
(10) Pub. No.: US 2026/0133422 A1
(43) Pub. Date: May 14, 2026

(54) DISPLAY SYSTEM AND VEHICLE

(71) Applicant: SHANGHAI TIANMA MICROELECTRONICS CO., LTD., Shanghai (CN)

(72) Inventors: Ailing YANG, Shanghai (CN); Yang ZENG, Shanghai (CN)

(21) Appl. No.: 19/429,711

(22) Filed: Dec. 22, 2025

(30) Foreign Application Priority Data
Jul. 31, 2025 (CN) 202511075156.0

(51) Int. Cl. G02B 27/01; G02B 27/09

(52) U.S. Cl. CPC G02B 27/0101; G02B 27/0972; G02B 2027/011; G02B 2027/0112

(57) ABSTRACT

Provided are a display system and a vehicle. The display system includes a display assembly, a main visual area and an eye box. The display assembly includes a display panel and a prism assembly, the prism assembly includes a plurality of prisms, and the prism assembly is located on a light-emitting side of the display panel. Along a first direction of the plane of the eye box, a width of the main visual area is W, and the width of an eye box is W₀, where W₀≤W≤1.5*W₀. According to the present disclosure, the relationship between the width of the main visual area and the width of the eye box in the display system is designed to improve glasses-free 3D display effect.

### CROSS-REFERENCE TO RELATED APPLICATION

The present disclosure claims priority to Chinese Patent Application No. 202511075156.0, filed on Jul. 31, 2025, the content of which is incorporated herein by reference in its entirety.

### TECHNICAL FIELD

The present disclosure relates to the field of display technologies, and in particular, to a display system and a vehicle.

### BACKGROUND

Glasses-free 3D is a technology that enables the achievement of stereoscopic visual effects without the need to wear glasses. It separates left-eye and right-eye images through methods such as light barriers, cylindrical lenses, and directional light sources, and forms three-dimensional perception using the parallax principle. Its core technologies include parallax barriers, micro-cylindrical lens arrays, and pupil tracking, and it is widely used in fields such as gaming devices, advertising screens, and medical education. Currently, there is also research on realizing glasses-free 3D in a head-up display (HUD). One problem of the current research is how to design relevant parameters in a display system to achieve better 3D effects.

### SUMMARY

Embodiments of the present disclosure provide a display system and a vehicle to improve the 3D display effect by designing related parameters in the display system.

In a first aspect, an embodiment of the present disclosure provides a display system, including a display assembly, a main visual area, and an eye box. The display assembly includes a display panel and a prism assembly, the prism assembly is located on a light-emitting side of the display panel, and the prism assembly includes a plurality of prisms. In a first direction of the plane where the eye box is located, a width of the main visual area is W, and a width of the eye box is W₀, where W₀≤W≤1.5*W₀.

In a second aspect, an embodiment of the present disclosure further provides a vehicle, including a display system. The display system includes a display assembly, a main visual area, and an eye box. The display assembly includes a display panel and a prism assembly, the prism assembly is located on a light-emitting side of the display panel, and the prism assembly includes a plurality of prisms. In a first direction of the plane where the eye box is located, a width of the main visual area is W, and a width of the eye box is W₀, where W₀≤W≤1.5*W₀.

### BRIEF DESCRIPTION OF DRAWINGS

In order to better illustrate the technical solutions in embodiments of the present disclosure or the related art, the drawings used in the description of the embodiments will be briefly illustrated as follows. It should be noted that, the drawings described below are merely some of, rather than all of the embodiments of the present disclosure. Based on these drawings, those skilled in the art can obtain other drawings without any creative efforts.

FIG. 1 is a simplified schematic diagram of a display system according to an embodiment of the present disclosure;

FIG. 2 is a schematic diagram of an eye box in a display system according to an embodiment of the present disclosure;

FIG. 3 is a schematic top view diagram of a display assembly in another display system according to an embodiment of the present disclosure;

FIG. 4 is a schematic cross-sectional diagram at line A-A′ shown in FIG. 3;

FIG. 5 is a schematic diagram of a field of view angle in another display system according to an embodiment of the present disclosure;

FIG. 6 is a schematic diagram of a display assembly in another display system according to an embodiment of the present disclosure;

FIG. 7 is a schematic diagram of a display assembly in another display system according to an embodiment of the present disclosure;

FIG. 8 is a flowchart of measuring a width of a main visual area according to an embodiment of the present disclosure;

FIG. 9 is a principle schematic diagram of a method for measuring a width of a main visual area according to an embodiment of the present disclosure;

FIG. 10 is a schematic diagram of a relationship between a maximum intensity angle and a measurement site.

FIG. 11 is an optical principle schematic diagram of a cylindrical prism;

FIG. 12 is a schematic diagram of a target sub-pixel selection in another method for measuring a width of a main visual area according to an embodiment of the present disclosure;

FIG. 13 is a schematic diagram of another method for measuring a width of a main visual area according to an embodiment of the present disclosure; and

FIG. 14 is a schematic diagram of a vehicle according to an embodiment of the present disclosure.

### DESCRIPTION OF EMBODIMENTS

In order to more clearly illustrate objectives, technical solutions, and advantages of embodiments of the present disclosure, the technical solutions in embodiments of the present disclosure are clearly and completely described in detail with reference to the drawings. It should be noted that, the embodiments described are only some rather than all of the embodiments of the present disclosure. Based on the embodiments of the present disclosure, all other embodiments obtained by those ordinary skilled in the art without creative efforts shall fall within the protection scope of the present disclosure.

Terms used in the embodiments of the present disclosure are only for the purpose of describing specific embodiments but not intended to limit the present disclosure. The singular forms of “a/an”, “said” and “the” used in the embodiments of the present disclosure and the appended claims are also intended to indicate plural forms, unless clearly indicating others.

An embodiment of the present disclosure provides a display system, which designs the relationship between a width of a main visual area and a width of an eye box in the display system to improve the glasses-free 3D display effect. Further, a length of the image source and an angle of the main visual area are designed to meet the requirement of the main view area width. Moreover, a focal length of the prism in the display system is designed. In addition, an embodiment of the present disclosure further provides a method for measuring the width of the main visual area applied to the display system, to meet the design requirement of realizing a glasses-free 3D system. The above is the main technical idea of the present disclosure, and the technical solution of the present disclosure will be explained below in specific embodiments.

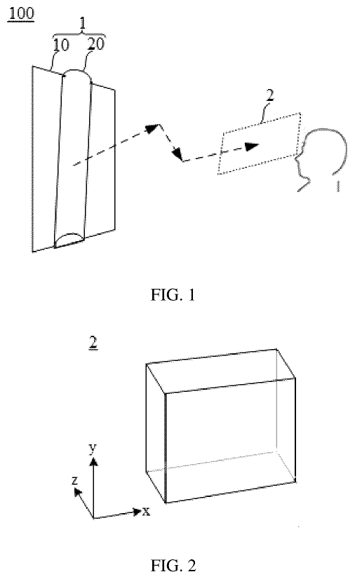

FIG. 1 is a simplified schematic diagram of a display system according to an embodiment of the present disclosure. FIG. 2 is a schematic diagram of an eye box in a display system according to an embodiment of the present disclosure. As shown in FIG. 1, the display system 100 includes a display assembly 1, a main visual area and an eye box 2. The display assembly 1 includes a display panel 10 and a prism assembly, the prism assembly includes a plurality of prisms 20, and the prisms 20 are located on a light-emitting side of the display panel 10. The prism 20 is a cylindrical prism. The display system 100 includes a plurality of prisms 20, and only one prism 20 is shown in FIG. 1.

The eye box 2 refers to the three-dimensional spatial range where the human eye can fully observe the displayed image. During viewing, the human eye needs to be within the spatial area range of eye box 2, exceeding this area will cause the image to be blurred, distorted, or disappear. In the coordinate system shown in FIG. 2, direction x, direction y, and direction z are perpendicular to each other. The eye box 2 has certain dimensions in direction x, direction y, and direction z, respectively. In applications, the direction x is a horizontal direction parallel to the ground and parallel to the arrangement direction of the user's two eyes, the direction x is defined as the horizontal direction, and it is the direction in which the human eyes move left and right under normal use conditions; the direction y is perpendicular to the ground and perpendicular to the direction x, the direction y is defined as the vertical direction, and it is the direction in which the human eyes move up and down under normal use conditions; the direction z is parallel to the ground and perpendicular to the direction x, the direction z is defined as the depth direction, and it is the direction in which the human eyes move forward and backward under use normal conditions.

In a 3D display system, a visual area refers to a continuous area where human eyes can view a complete 3D image without cracks and discontinuities. In a display system in which cylindrical prisms are used to realize the glasses-free 3D, the visual area appears periodically along a direction perpendicular to an axial direction of the prisms (i.e., the arrangement direction of the prisms). One visual area corresponds to a group of light exited from the prisms, where the light originates from a pixel group overlapping with the prisms. The visual area of the eye box 2 covered by light is the main visual area.

In an embodiment of the present disclosure, along a first direction of the plane where the eye box 2 is located, a width of the main visual area is W, and a width of the eye box 2 is W₀, where W₀≤W≤1.5*W₀. During normal use by the user, when the dimension of the eye box 2 in the direction z is set to an extremely small value, the eye box 2 can be approximated as a plane. This plane is the plane where the eye box 2 is located, and it is perpendicular to the ground, with the user's eyes positioned within the plane where the eye box 2 is located. The first direction is a direction in which human eyes move left and right when the user normally uses the display system, i.e., a horizontal direction parallel to the ground when the user normally uses the display system. The first direction is parallel to the plane where the eye box 2 is located, and the first direction is the direction x shown in FIG. 2.

According to the display system provided by an embodiment of the present disclosure, there is a certain relationship between the width W₀ of the eye box 2 and the width W of the main vision area in the first direction of the plane where the eye box 2 is located, where W₀≤W≤1.5*W₀. The width W of the main visual area is set to be not less than the width W₀ of the eye box 2, so as to ensure that human eyes can see a clear and complete 3D image in the eye box 2, and human eyes cannot see repeated pictures when moving in the eye box 2, thereby ensuring a 3D viewing effect. In addition, the width W of the main vision area is not too large to avoid waste of light data caused by excessive light emitted from the display assembly 1 exceeding the range of the eye box 2.

In some embodiments, W₀<W≤1.5*W₀. The width W of the main visual area is set to be greater than the width W₀ of the eye box 2, and the width W of the main vision area is not too large, so that the main vision area light emitted from the display assembly 1 can completely cover the area of the eye box 2, which ensures that human eyes can see a clear and complete 3D image in the eye box 2, and it can avoid waste of light data caused by excessive light emitted from the display assembly 1 exceeding the range of the eye box 2.

In some embodiments, 1.1*W₀≤W≤1.5*W₀. For example, W=1.1*W₀, or W=1.2*W₀, or W=1.3*W₀, or W=1.4*W₀.

In some embodiments, 1.2*W₀≤W≤1.4*W₀.

In some embodiments, 1.2*W₀≤W≤1.3*W₀.

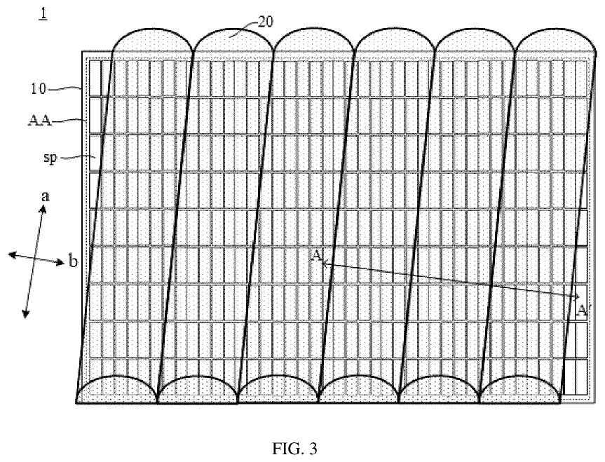

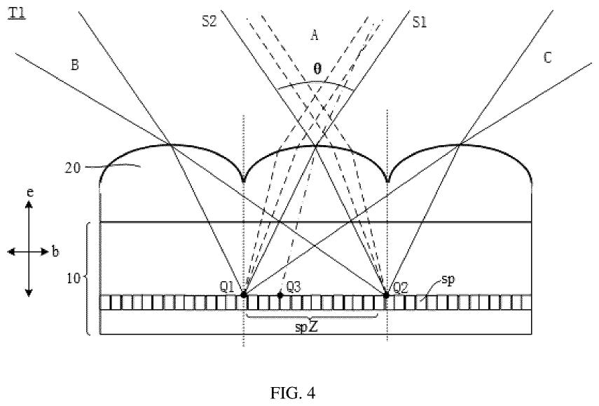

In some embodiments, FIG. 3 is a schematic top view diagram of a display assembly in another display system according to an embodiment of the present disclosure, and FIG. 4 is a schematic cross-sectional view at a line A-A′ in FIG. 3. FIG. 3 is a top view of the display assembly, and it can be understood that the top view direction is parallel to the direction perpendicular to the display panel 10.

As shown in FIG. 3, the display panel 10 includes a display area AA, the display area AA includes a plurality of sub-pixels sp, and the plurality of sub-pixels sp include sub-pixels of three colors of red, green and blue. The arrangement of the plurality of sub-pixels sp is not limited in the embodiments of the present disclosure, and the arrangement of the plurality of sub-pixels sp in FIG. 3 is merely illustrative. It can be seen from FIG. 3 that a pixel group spZ (shown in FIG. 4) is formed by a plurality of sub-pixels sp overlapping with the prisms 20 along a direction e perpendicular to a plane where the display panel 10 is located (shown in FIG. 4). FIG. 3 shows an axial direction a of the prism, a direction b is perpendicular to the axial direction a of the prism, and the direction b is an arrangement direction of the plurality of prisms 20 and a width direction of the prism 20. It can be understood that the prisms 20 overlap with a plurality of sub-pixels sp arranged in the direction b, and the number of sub-pixels sp overlapping with the prisms 20 in FIG. 3 is merely illustrative. Optionally, one prism 20 overlaps with 6 to 30 sub-pixels sp arranged in the direction b. Optionally, the number of the sub-pixels sp overlapping with one prism 20 in the direction b may not be an integer, for example, one prism 20 overlaps with 6.2 sub-pixels sp arranged in the direction b, that is, the width of the prism 20 in the direction b is not an integer multiple of the width of the sub-pixel sp.

FIG. 3 shows that the line A-A′ is parallel to the direction b, i.e., the line A-A′ is perpendicular to the axial direction a of the prism 20. FIG. 4 illustrates a cross-sectional view of the display panel 10 in a first plane T1 perpendicular to the axial direction of the prism 20. FIG. 4 illustrates three pixel groups spZ and three prisms 20 respectively overlapping with the three pixel groups spZ and illustrates an optical path of light emitted by the pixel group spZ at a middle position in the three pixel groups spZ after being acted by the prisms 20.

As shown in FIG. 4, the light emitted by the pixel groups spZ will travel toward the prism 20 overlapping therewith, and also toward the prisms 20 adjacent to the prism 20 overlapping therewith. The light emitted by the pixel group spZ at the middle position among the three pixel groups spZ, after being exited from the prism 20 overlapping therewith, falls in area A, the light emitted by this pixel group (spZ), after being acted on and exited from the prisms 20 on the left and right sides, falls in area B and area C respectively. The light emitted by the pixel group spZ, after being exited from the prism 20 overlapping therewith, is the main visual area light. FIG. 4 shows that the light emitted by the pixel group spZ at the middle position and falls in the area A through the prism 20 overlapping therewith is the main visual area light. The angle range of the main visual area light in the first plane T1 is a main visual area angle θ. FIG. 4 shows that two critical light rays of the main visual area light in the first plane T1 are S1 and S2 respectively, and the directions of the light ray S1 and the light ray S2 are different.

FIG. 4 shows two light-emitting sites Q1 and Q2 in the first plane T1, and the two light-emitting sites Q1 and Q2 are light-emitting sites at two side edges of the pixel group spZ at the middle position. According to the optical principle of the cylindrical prism, it can be known that the light emitted from the light-emitting site Q1 to different positions of the same prism 20 in the first plane T1 forms a group of parallel light after being acted by the prism 20, i.e., all of the light emitted by the light-emitting site Q1 and exited from the prism 20 overlapping therewith is parallel to the light ray S1. Similarly, all of the light emitted by the light-emitting site Q2 and exited from the prism 20 overlapping therewith is parallel to the light ray S2. All of the light emitted by the light-emitting sites between the light-emitting sites Q1 and Q2 falls within the range of the area A, and the included angle between the light rays S1 and S2 is equal to the main visual area angle θ.

The display system further has a field of view angle. In a 2D display system, the field of view angle is an angle of line connecting lines between edges of the display and view points (eyes). The field of view angle in a 3D display system is an included angle of line connecting lines between edges of a virtual image and the view points, and the field of view angle in the 3D display system may be designed with reference to the field of view angle in the 2D display system.

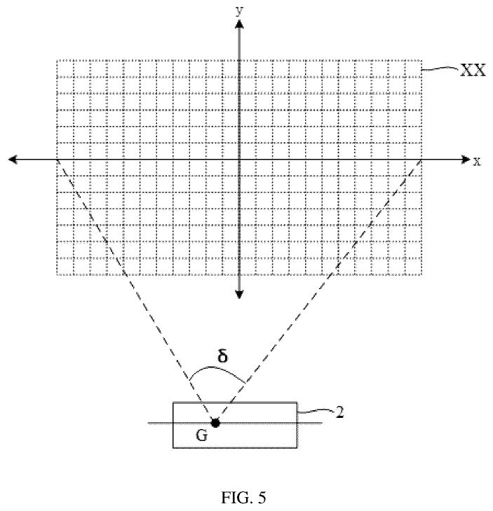

FIG. 5 is a schematic diagram of a field of view angle in another display system according to an embodiment of the present disclosure. As shown in FIG. 5, the light emitted from the display assembly 1 in the display system is reflected and then enters the virtual image XX of the image of the eye box 2, a plane where the virtual image XX is located is parallel to a plane where the direction x and the direction y are located, and the direction x and the direction y can be referred to the description of an embodiment in FIG. 2. An included angle of line connecting lines between two edges of the virtual image XX and the view point G in the eye box 2 is a field of view angle δ in the display system. FIG. 5 illustrates a field of view angle δ in a horizontal direction (parallel to ground) in normal use conditions, i.e., a horizontal field of view angle.

According to the Conservation of Optical Étendue, the product of the beam width and the beam angle is a constant value. In the 3D display system, the product of the length of the image source in the direction perpendicular to the axial direction a of the prism 20 and the main visual area angle θ is approximately equal to the product of the width W of the main visual area and the field of view angle δ in the direction of the width W of the main visual area. The display area AA of the display panel 10 is an image source of the display system. Then, the main visual area angle θ satisfies the following relationship: L*θ=W*δ; where Lis a length of the display area AA in the direction perpendicular to the axial direction a of the prism 20, i.e., Lis a length of the display area AA in the direction b in FIG. 3; and δ is the field of view angle. Specifically, δ is a horizontal field of view angle.

In the display system, L and δ are known quantities, and the relationship between W and W₀ is known, based on the above formula, the main visual area can be derived, i.e., θ=(W*δ)/L. Further, the morphology of the prism 20 which meets the requirement can be designed according to the main visual area angle θ, and the design requirement of W₀≤W≤1.5*W₀ is realized.

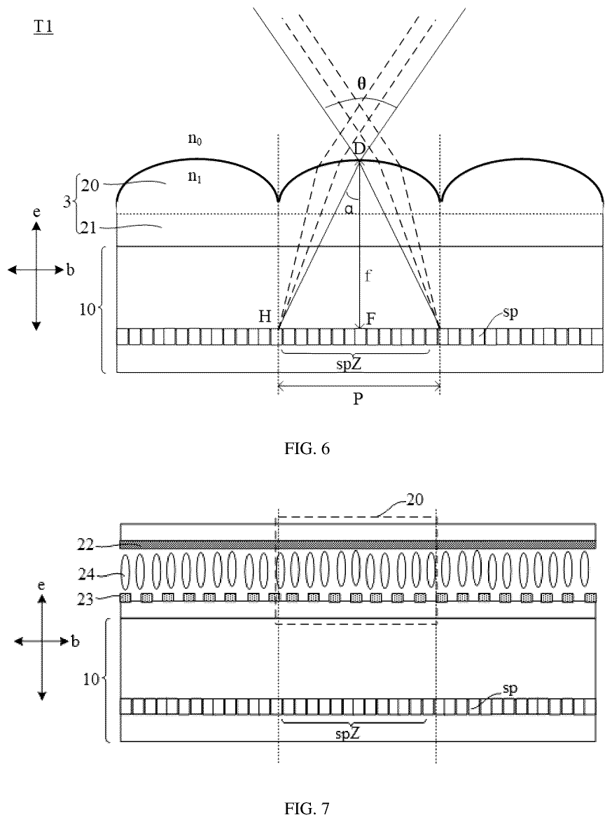

In some embodiments, FIG. 6 is a schematic diagram of a display assembly in another display system according to an embodiment of the present disclosure. FIG. 6 illustrates a cross-sectional view of the display assembly in the first plane T1. The direction b is parallel to the first plane T1. As shown in FIG. 6, the light emitted by the light-emitting sites (i.e., sub-pixels) in the pixel group spZ forms a group of parallel light after being exited from the prism 20, so the light-emitting sites in the pixel group spZ are approximately located on the focal plane of the prism 20. That is, along the direction e perpendicular to the plane where the display panel 10 is located, a maximum distance between the prism 20 and the plane where the sub-pixels sp are located is f, and f is the focal length of the prism 20. In other words, the maximum distance between the light-emitting surface of the sub-pixel sp and the prism 20 is f.

As shown in FIG. 6, the light emitted by the pixel group spZ forms the main visual area light after being acted by the prism 20, and the main visual area light has the main visual area angle θ within the first plane T1. The angle α can be calculated according to the law of refraction, where n₀*sin(θ/2)=n₁*sin α, and α=arcsin((n₀/n₁)*sin(θ/2)). n₀ is the air refractive index, and n₁ is the equivalent refractive index of the prism 20.

In FIG. 6, the ΔDFH is a right triangle, and a length of the right side HF of the ΔDFH is half the width of the prism 20, in other words, the length of the right side HF of the ΔDFH is half the length of the pixel group spZ in direction b, where a width of the prism 20 is P, and a length of HF is P/2. A triangular function formula is applied to ΔDFH to obtain the focal length f of the prism 20, which satisfies the following relationship:

$$f = \frac{P}{2 * tan ( arcsin \frac{{n}_{0} sin \frac{θ}{2}}{{n}_{1}} )} .$$

According to an embodiment of the present disclosure, the focal length f of the prism 20 can be calculated according to the main visual area angle θ, the width P of the prism 20 and the refractive index of the prism 20. After the focal length f of the prism 20 is calculated, a radius of curvature and a thickness of the prism 20 may be obtained through simulation, so that the morphology of the prism 20 meets design requirements.

In some embodiments, as shown in FIG. 6, the prism assembly is a prism film 3, and the prism film 3 includes a plurality of prisms 20. The prism film 3 and the display panel 10 are aligned and bonded together, and an optical adhesive may be disposed therebetween. The bonding process of the prism film 3 and the display panel 10 is simple, and the optical performance of the prism film 3 is excellent. The prism film 3 includes a substrate 21, and a plurality of prisms 20 are formed on the substrate 21. The substrate 21 may be a polyethylene terephthalate (PET) substrate.

In some other embodiments, FIG. 7 is a schematic diagram of a display assembly in another display system according to an embodiment of the present disclosure. As shown in FIG. 7, the prism assembly is a liquid crystal prism. The prism 20 includes a common electrode 22 and a plurality of prism electrodes 23. Along a direction e perpendicular to the plane of the display panel 10, the common electrode 22 overlaps with the plurality of prism electrodes 23. Liquid crystal molecules 24 are sandwiched between the common electrode 22 and the plurality of prism electrodes 23. Voltages are respectively applied to the common electrode 22 and the plurality of prism electrodes 23, and the voltages of the plurality of prism electrodes 23 in one prism 20 is controlled to be in a specific voltage distribution, so that an electric field formed between the common electrode 22 and the plurality of prism electrodes 23 can control the orientation of the liquid crystal molecules 24 to form a specific distribution, and the optical function of the liquid crystal molecules 24 can be equivalent to a cylindrical prism.

As shown in FIG. 3, the axial direction a of the prism 20 in an embodiment of the present disclosure is inclined relative to an edge of the display panel. The “inclined” means that the axial direction a of the prism 20 is not parallel or perpendicular to the edge of the display panel. That is, an acute angle is formed between the axial direction a of the prism 20 and the edge of the display panel. For example, the axial direction a of the prism 20 has an acute angle with any edge of a rectangular display panel. By means of the arrangement, the optical path direction can be adjusted, and the stereoscopic visual effect is improved.

In some embodiments, the display system further includes a reflective structure configured to reflect the light exited from the prism 20 and travel the reflected light to the eye box 2. Optionally, the reflective structure includes at least two reflective sheets. The display system provided by this embodiment may be a head-up display (HUD), and the present disclosure can achieve the 3D display effect of the head-up display.

In addition, the type of the display panel 10 is not limited in the embodiments of the present disclosure. The display panel 10 may be, for example, a liquid crystal display panel, an organic light-emitting display panel, or an electronic paper.

Based on the same inventive concept, an embodiment of the present disclosure further provides a method for measuring a width of a main visual area, which can be used to measure the width W of the main visual area in the display system provided by the embodiment of the present disclosure.

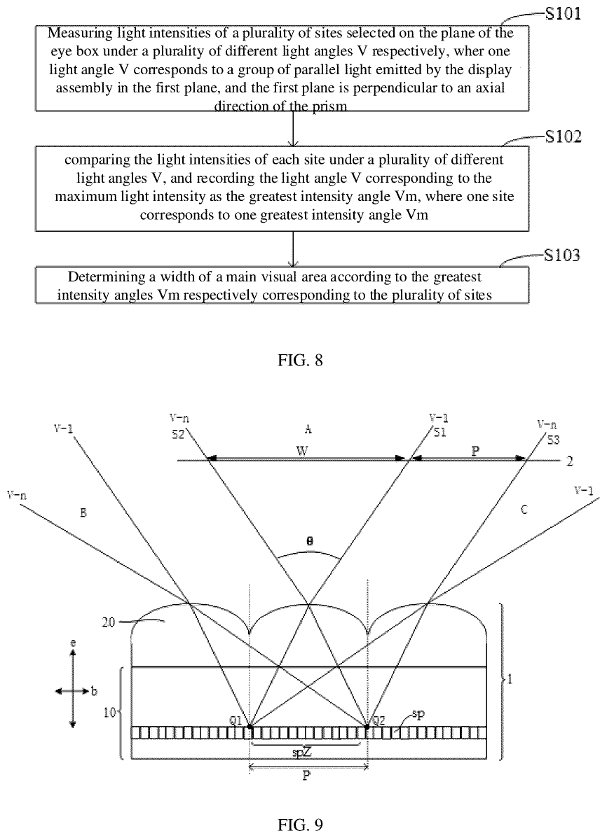

FIG. 8 is a flowchart of measuring a width of a main visual area according to an embodiment of the present disclosure. As shown in FIG. 8, the method for measuring a width of a main visual area includes steps of S101, S102, and S103.

In step S101, light intensities of a plurality of sites selected on the plane where the eye box 2 is located are measured under a plurality of different light angles V respectively, where one light angle V corresponds to a group of parallel light emitted by the display assembly 1 in the first plane, and the first plane is perpendicular to the axial direction of the prism 20. Different light angles refer to the fact that a fixed direction is selected as a reference direction, and light forming different included angles with the reference direction has different light angles.

Referring to the schematic diagram of FIG. 4, the light emitted by the light-emitting sites Q1, Q2 and Q3 of the pixel group spZ at the middle position, after being exited from the prism 20, has light angles V respectively in the first plane T1, and the light angles V corresponding to the three light-emitting sites Q1, Q2 and Q3 are different. Light emitted by one light-emitting site of the pixel group spZ, after being exited from the prism 20, forms a group of parallel light in the first plane T1. By respectively controlling the sub-pixels sp at different positions in the pixel group spZ to emit light, the display assembly 1 can be controlled to emit light having different light angles V. For example, M sites are selected on the plane where the eye box 2 is located, and M is a positive integer, when the display assembly 1 emits a group of light having the light angles V, light intensities at the M sites are measured, i.e., one light intensity data is measured at each site corresponding to each light angle V. Then, the light angle V of the light emitted by the display assembly 1 is switched, and each light intensities at M sites are respectively measured again. If N different light angles V are set, and N is a positive integer, N light intensities need to be measured at each site, i.e., each site corresponds to light intensity data at N different light angles V.

For example, M sites are selected in the plane where the eye box 2 is located and N different light angles V are set. M sites E are selected, and the i-th site is marked as Ei, 1≤i≤M; N different light angles V are set, and the j-th site is marked as Vj, 1≤j≤N. Lij represents the light intensity at light angle Vj at the i-th site. After step S101, the following table is obtained:

TABLE 1
light intensity record table of each site under different light angles

| | E1 | E2 | E3 | . . . | EM |
|---|---|---|---|---|---|
| V1 | L11 | L21 | L31 | . . . | LM1 |
| V2 | L12 | L22 | L32 | . . . | LM2 |
| V3 | L13 | L23 | L33 | . . . | LM3 |
| . . . | . . . | . . . | . . . | . . . | . . . |
| VN | L1N | L2N | L3N | . . . | LMN |

In step S102, light intensities of each site under a plurality of different light angles V are compared to each other, and a light angle V corresponding to the maximum light intensity is recorded as a greatest intensity angle Vm, where one site corresponds to one greatest intensity angle Vm. That is, light intensities measured at each site under N different light angles V are different, a light angle corresponding to the maximum light intensity is selected as the greatest intensity angle Vm at the site, and the selected M sites respectively correspond to one greatest intensity angle Vm.

In step S103, a width of a main visual area is determined according to the greatest intensity angles Vm respectively corresponding to the plurality of sites.

According to the method provided in an embodiment of the present disclosure, the display assembly 1 is controlled to emit light of a plurality of different light angles V, and the light intensity at each light angle V is measured at each of a plurality of sites on the plane where the eye box 2 is located, then the light angle V corresponding to the maximum light intensity at each site is selected as the greatest intensity angle Vm, and the width W of the main visual area of the display system can be determined according to the greatest intensity angles Vm respectively corresponding to the plurality of sites.

FIG. 9 is a principle schematic diagram of a method for measuring a width of a main visual area according to an embodiment of the present disclosure. In the three pixel groups spZ shown in FIG. 9, light is emitted by the pixel group spZ at the middle position to the three prisms 20, and three light visual areas are formed after being acted by the three prisms 20, namely, an area A, an area B, and an area C, respectively. The light in the area A is main visual area light. Two critical light rays of each visual area have a light angle V-1 and a light angle V-n, respectively. Light having the light angle V-1 and the light angle V-n are emitted by the light-emitting sites Q1 and Q2 in the pixel group spZ, respectively, and then exited from the prism 20. That is, the light emitted by the light-emitting sites at both side edges of the pixel group spZ, after being exited from the prism 20, defines the range of the visual area.

A reflective structure is further provided in the display system, and light emitted by the display assembly 1 is reflected by the reflective structure and then is travelled to a position where the eye box 2 is located. Although the reflective structure is not shown in FIG. 9, it can be understood that the light emitted by display assembly 1 with different light angles V, after being reflected by the reflection structure, maintain unchanged angular relationships between the reflected light corresponding to the light of different angles V. For example, an included angle θ is formed between the light S1 and the light S2 emitted by the display assembly 1, and an included angle θ is also formed between two reflected light after the light S1 and the light S2 are respectively reflected by the reflective structure. Therefore, only the optical path is simplified in FIG. 9, and the reflected optical path is not shown.

Taking the display system as a head-up display system as an example, in practice, the plane where the eye box 2 is located is far away from the display assembly 1. The light S1, the light S2 and the light S3 all reach the plane where the eye box 2 is located after being reflected, the width W of the main visual area is the coverage width of the light emitted by one pixel group spZ through one prism 20 on the plane where the eye box 2 is located, and a distance between the sites on the plane where the eye box 2 is located that are reached by the light S1 and the light S2 after being reflected is the width W of the main visual area. In addition, the light S3 and the light S1 are parallel light, and a distance between the sites on the plane where the eye box 2 is located, reached by the light S3 and light S1 after being reflected, is the width P of the prism 20 in direction b. From a spatial distance perspective, the width P of the prism 20 is very small (about several hundred micrometers) and can be ignored when measured. That is, it can be considered that the light S3 and the light S1 reach the same site on the plane where the eye box 2 is located after being reflected, and the width W of the main visual area can be obtained by calculating a distance between the sites on the plane where the eye box 2 is located that are reached by the light S3 and the light S2 after being reflected. Because both the light S3 and the light S2 are light emitted by the light-emitting site Q2 and exited from the prism 20, both the light S3 and the light S2 have a light angle V-n. Therefore, by measuring the light intensities of a plurality of sites on the plane where the eye box 2 is located at a plurality of different light angles V respectively, the positions of the sites on the plane where the eye box 2 is located that are reached by the light S3 and the light S2 after being reflected can be determined, so that the width W of the main visual area can be determined.

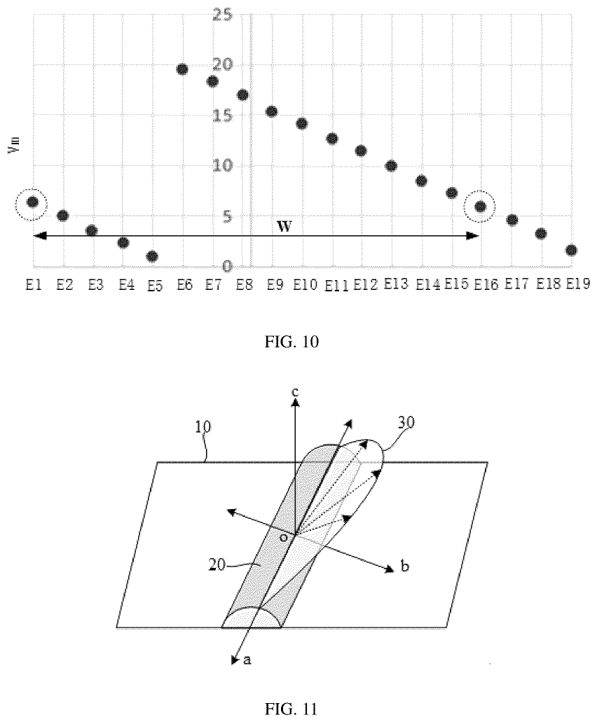

FIG. 10 is a schematic diagram of a relationship between a greatest intensity angle and a measurement site. By adopting the method for measuring the width of the main visual area provided by an embodiment of the present disclosure, 19 measurement sites E from E1 to E19 are selected on the plane where the eye box 2 is located, and 20 light angles V are set. The 20 light angles V are represented by 1, 2, 3, 4 . . . to 20, respectively. After step S102, the greatest intensity angle Vm corresponding to each site E is determined, and each group of data is drawn into a dot graph as shown in FIG. 10. It can be seen from FIG. 10 that the greatest intensity angle Vm of the site E1 is approximately equal to the greatest intensity angle Vm of the site E16, and an interval between the site E1 and the site E16 is the width W of the main visual area. For example, if each site E is selected at equal intervals, and a plurality of sites E are located on a same virtual straight line, the interval between two adjacent sites E is d, and the site E1 and the site E16 are separated by 15 intervals d, the width W of the main visual area is 15*d.

In some embodiments, step S103 of determining the width of the main visual area according to the greatest intensity angles Vm respectively corresponding to the plurality of sites W includes: comparing the greatest intensity angles Vm respectively corresponding to the plurality of sites, and obtaining an interval between two sites corresponding to two same greatest intensity angles Vm as the width W of the main visual area. According to the principle illustrated in the embodiment of FIG. 9, by adopting the method provided by an embodiment of the present disclosure, the light intensities of a plurality of sites on the plane where the eye box 2 is located under a plurality of different light angles V are respectively measured, the corresponding greatest intensity angle Vm is determined at each site, and a distance between two sites where the greatest intensity angle Vm (i.e., the same greatest intensity angle) is repeated is the width W of the main visual area.

In some embodiments, the step S101 of measuring the light intensities of a plurality of sites selected on the plane where the eye box 2 is located under a plurality of different light angles V respectively includes: step S1011 of controlling the light emitted by the display assembly 1 to have a light angle V in the first plane; and step S1012 of photographing the virtual image at the plurality of sites selected from the plane where the eye box 2 is located to obtain light intensities at the plurality of sites.

Through the above steps S1011 and S1012, the light intensities of the plurality of sites selected from the plane where the eye box 2 is located under the same light angle V can be measured. After the light intensity measurement under the light angle V is completed once, the light angle of the light emitted by the display assembly 1 is switched to perform the next measurement. When N light angles V are selected, the data collection of light intensities is completed through N times of steps S1011 and S1012.

Referring to FIG. 3 and FIG. 4, the display panel 10 includes a display area AA, the display area AA includes a plurality of sub-pixels sp, and the plurality of sub-pixels sp overlapping with the prisms 20 along a direction perpendicular to a plane where the display panel 10 is located form pixel groups spZ.

FIG. 11 is an optical principle schematic diagram of a cylindrical prism. FIG. 11 schematically illustrates a display panel 10 and one prism 20 overlapping therewith. In the three-dimensional coordinate system shown in FIG. 11, o is an origin, an axial direction of the prism 20 is parallel to the direction a, a direction b is perpendicular to the direction a, and a direction c is perpendicular to the direction a and the direction b respectively. As shown in FIG. 10, the prism 20 is a cylindrical prism, the cylindrical prism is a one-dimensional light deflection element, and the prism 20 has a deflection effect on light in a plane formed by the direction b and the direction c, and has no light deflection effect on light in a plane formed by the direction a and the direction c. Ideally, the sub-pixels sp in the display panel 10 are regarded as point light sources, and the spherical light emitted by the sub-pixels sp is condensed in the plane formed by the direction b and the direction c after being acted by the prism 20, that is, the light is converged to form an area A as shown in FIG. 4. The spherical light emitted by the sub-pixels sp is not condensed in the plane formed by the direction a and the direction c after being acted by the prism 20 to form a fan-shaped planar light beam 30. The sub-pixels sp at different positions in the pixel group spZ emit light to form a plurality of fan-shaped planar light beams 30, and the plurality of fan-shaped planar light beams 30 have different included angles with the direction c, so that the plurality of fan-shaped planar light beams 30 converge in the area A shown in FIG. 4 to form the main visual area light. Moreover, the fan-shaped planar light beams 30 formed by light emitted from a plurality of sub-pixels sp in the pixel group spZ corresponding the same prism 20 may be located in the same plane. Based on this principle, a target sub-pixel may be selected from the pixel group spZ, and then the light angle V of the light emitted by the display assembly 1 is controlled by the target sub-pixel.

In some embodiments of the present disclosure, the step S1011 of controlling the light emitted by the display assembly 1 to have a light angle V in the first plane includes: selecting at least one sub-pixel sp from the pixel group spZ as the target sub-pixel according to the virtual line, the virtual line is located in an area where the pixel group spZ is located, and the virtual line is parallel to the axial direction of the prism 20; and lighting up the target sub-pixel to control light emitted by the display assembly 1 to have the light angle V. There may be one or more target sub-pixels corresponding to one light angle V.

By adopting the method provided by an embodiment of the present disclosure, the number of the virtual lines is determined according to the set number of the light angles V, then a plurality of target sub-pixels can be determined according to a plurality of virtual lines parallel to the axial direction of the prism 20, and further the light angle V of the light emitted by the display assembly 1 can be controlled by lighting up the target sub-pixels.

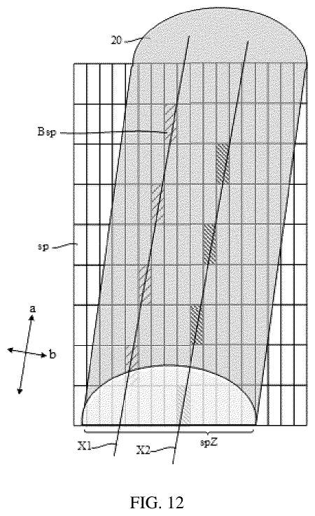

FIG. 12 is a schematic diagram of a target sub-pixel selection in another method for measuring a width of a main visual area according to an embodiment of the present disclosure. FIG. 12 illustrates a pixel group spZ overlapping with the prism 20 and illustrates two virtual lines located in an area where the pixel group spZ is located, which are a virtual line X1 and a virtual line X2 respectively. The target sub-pixels Bsp are determined according to the virtual line X1 and the virtual line X2, respectively, and the target sub-pixels Bsp are illustrated by pattern filling in FIG. 12, it can be seen that a target sub-pixel Bsp overlaps with the corresponding virtual line. The light emitted by the target sub-pixels Bsp determined by the virtual line X1 and the target sub-pixels Bsp determined by the virtual line X2, after being acted by the prism 20, has different light angles V.

In an embodiment of the present disclosure, the selecting at least one sub-pixel sp from the pixel group spZ as the target sub-pixel according to the virtual line Bsp includes: measuring a distance between a center of each of the plurality of sub-pixels sp in the pixel group spZ and a virtual line and selecting at least one sub-pixel sp whose distance is less than a distance threshold as the target sub-pixel Bsp. In an embodiment of the present disclosure, the prism 20 is inclined relative to the edge of the display panel, that is, an acute angle is formed between the axial direction a of the prism 20 and the edge of the display panel. The plurality of target sub-pixels Bsp selected according to the virtual lines parallel to the axial direction a of the prism 20 may be a plurality of discrete sub-pixels sp discontinuously adjacent to each other. In an embodiment of the present disclosure, the target sub-pixel Bsp is determined according to a distance between the sub-pixel sp to the virtual line parallel to the axial direction a of the prism 20, and when the plurality of target sub-pixels Bsp are selected, the light emitted by the plurality of target sub-pixels Bsp and exited from the prism 20 has the same light angle V. That is, one light angle V corresponds to a group of target sub-pixels Bsp.

In some embodiments, the step S101 of measuring light intensities of a plurality of sites selected on the plane where the eye box 2 is located under a plurality of different light angles V respectively includes: step S1010 of selecting a plurality of sites on the plane where the eye box 2 is located, where the plurality of sites are located on a same virtual straight line, and the virtual straight line is parallel to the first direction.

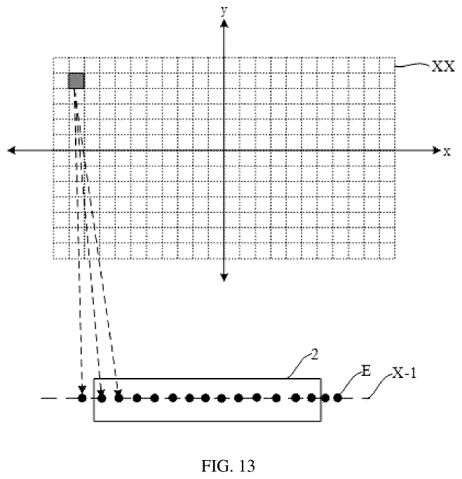

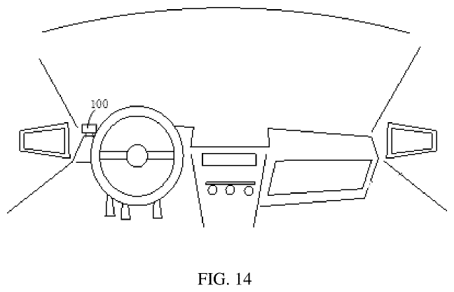

FIG. 13 is a schematic diagram of another method for measuring a width of a main visual area according to an embodiment of the present disclosure. FIG. 13 illustrates a plane where the virtual image XX is located and a position where the eye box 2 is located. As shown in FIG. 13, a plurality of sites E are selected on the plane where the eye box 2 is located, the plurality of sites E are located on a same virtual straight line X-1, the virtual straight line X-1 is parallel to the first direction, the first direction is the same as a left-right movement direction x of human eyes under the normal use condition, and the direction x is the same as the direction x of the eye box 2 shown in FIG. 2.

In an embodiment of the present disclosure, the plurality of sites E located on the same virtual straight line X-1 are selected on the plane where the eye box 2 is located, and when the display assembly 1 is controlled to emit light of the light angle V, the virtual image is photographed respectively at the plurality of sites E to obtain the light intensity at each site E.

In some embodiments, an interval between two adjacent sites E is d, where 20 μm≤d≤40 μm. The plurality of sites E may be arranged at equal intervals, or may be arranged at unequal intervals. In the case that the size of the eye box 2 is basically obtained, too small d will result in more measurement times and affect the measurement time, and too large d will affect the measurement accuracy although the measurement times are reduced. According to an embodiment of the present disclosure, the number of the sites E and the interval are set according to the size of the eye box 2, so that the measurement accuracy and the measurement time can be balanced, and it is ensured that a relatively short measurement time is utilized to achieve a more accurate measurement value of the width W of the main visual area.

In some embodiments, the step S101 of measuring light intensities of a plurality of sites selected on the plane where the eye box 2 is located under a plurality of different light angles V respectively includes: M sites are selected on the plane where the eye box 2 is located, where W₀/(40 μm)≤M−1≤1.5*W₀/(20 μm), and M is an integer. According to an embodiment of the present disclosure, the number of the selected measurement sites is set according to the width W₀ of the eye box 2 in the first direction, so that the number of the selected sites is not too small or too large, the measurement accuracy and the measurement time can be balanced, and it is ensured that a relatively short measurement time is utilized to achieve a more accurate measurement value of the width W of the main visual area.

In some embodiments, the step S101 of measuring light intensities of a plurality of sites selected on the plane where the eye box 2 is located under a plurality of different light angles V respectively includes: measuring light intensities of a plurality of sites selected on the plane where the eye box 2 is located under N different light angles V respectively, N is an integer, and N≥15. Optionally, N is about 20. According to an embodiment of the present disclosure, the number of the light angles V is set to be at least 15, so that the measurement accuracy of the width W of the main visual area can be ensured. Further, it is set that N≤30, which can save measurement time.

Based on the same inventive concept, an embodiment of the present disclosure further provides a vehicle, FIG. 14 is a schematic diagram of a vehicle provided by an embodiment of the present disclosure, and as shown in FIG. 14, the vehicle includes the display system 100 provided by any embodiment of the present disclosure. The display system 100 is a head-up display system, and the structure of the display system 100 has been described in an above embodiment and will not be repeated here. By adopting the display system 100 provided by the embodiments of the present disclosure, the 3D viewing effect can be realized, the human eyes can see a clear and complete 3D image in the eye box 2, and will not see repeated pictures when moving in the eye box 2, and it can avoid waste of light data due to excessive light emitted from the display assembly 1 exceeding the range of the eye box 2.

The above description merely illustrates some preferred embodiments of the present disclosure and is not intended to limit the present disclosure, and any modification, equivalent substitution, improvement and the like made within a spirit and a principle of the present disclosure shall fall with the scope of the present disclosure.

Finally, it should be noted that the above embodiments are merely used to illustrate the technical solutions of the present disclosure but not to limit the same. Although the present disclosure has been described in detail with reference to the above embodiments, those skilled in the art should understand that the technical solutions described in the above embodiments of the present disclosure may still be modified, or some or all of the technical features may be equivalently replaced. These modifications or substitutions do not make the essence of the corresponding technical solutions depart from the scope of the technical solutions in the embodiments of the present disclosure.

What is claimed is:

1. A display system, comprising:
a display assembly, wherein the display assembly comprises a display panel and a prism assembly, the prism assembly is located on a light-emitting side of the display panel, and the prism assembly comprises a plurality of prisms;
a main visual area; and
an eye box,
wherein in a first direction of a plane of the eye box, a width of the main visual area is W, and a width of the eye box is W₀, where W₀≤W≤1.5*W₀.

2. The display system according to claim 1, wherein W₀<W≤1.5*W₀.

3. The display system according to claim 1, wherein the display panel comprises a display area, the display area comprises a plurality of sub-pixels, and sub-pixels overlapping with one of the plurality of prisms along a direction perpendicular to a plane of the display panel form a pixel group;
light emitted by the pixel group and exited from a prism overlapping therewith is main visual area light, an angle range of the main visual area light in a first plane is a main visual area angle θ, the first plane is perpendicular to an axial direction of the prism, and the main visual area angle θ satisfies following relationship:
$$L * θ = W * δ ,$$
wherein L is a length of the display area in a direction perpendicular to the axial direction of the prism, and δ is a field of view angle.

4. The display system according to claim 3, wherein a focal length f of the prism satisfies following relationship:
$$f = \frac{P}{2 * tan ( arcsin \frac{{n}_{0} sin \frac{θ}{2}}{{n}_{1}} )} ,$$
wherein P is a width of the prism, no is an air refractive index, and n₁ is an equivalent refractive index of the prism.

5. The display system according to claim 4, wherein along the direction perpendicular to the plane of the display panel, a maximum distance between the prism and the plane of the sub-pixels is f.

6. The display system according to claim 1, wherein the prism assembly is a prism film, or the prism assembly is a liquid crystal prism.

7. The display system according to claim 1, wherein an axial direction of one of the plurality of prisms is inclined relative to an edge of the display panel.

8. The display system according to claim 1, further comprising:
a reflective structure configured to reflect light exited from the plurality of prisms and direct the reflected light towards the eye box.

9. The display system according to claim 1, wherein the width of the main visual area is measured by following steps:
measuring light intensities of a plurality of sites selected on the plane of the eye box under a plurality of different light angles V respectively, wherein one light angle V corresponds to a group of parallel light emitted by the display assembly in a first plane, and the first plane is perpendicular to an axial direction of one of the plurality of prisms;
comparing the light intensities of each of the plurality of sites under a plurality of different light angles V, and recording a light angle V corresponding to a maximum light intensity as a greatest intensity angle Vm, wherein one site corresponds to one greatest intensity angle Vm; and
determining the width of the main visual area based on the greatest intensity angles Vm respectively corresponding to the plurality of sites.

10. The display system according to claim 9, wherein the determining the width of the main visual area based on the greatest intensity angles Vm respectively corresponding to the plurality of sites comprises:
comparing the greatest intensity angles Vm respectively corresponding to the plurality of sites, and determining an interval between two sites corresponding to two same greatest intensity angles Vm as the width of the main visual area.

11. The display system according to claim 9, wherein the measuring light intensities of a plurality of sites selected on the plane of the eye box under a plurality of different light angles V respectively comprises:
controlling the light emitted by the display assembly to have a light angle V in the first plane; and
photographing a virtual image at the plurality of sites selected on the plane of the eye box to obtain light intensities at the plurality of sites.

12. The display system according to claim 11, wherein the display panel comprises a display area, the display area comprises a plurality of sub-pixels, and sub-pixels overlapping with one of the plurality of prisms along a direction perpendicular to a plane of the display panel form a pixel group;
the controlling the light emitted by the display assembly to have a light angle V in the first plane comprises:
selecting at least one sub-pixel from the pixel group as a target sub-pixel based on a virtual line, wherein the virtual line is located in an area of the pixel group, and the virtual line is parallel to an axial direction of one of the plurality of prisms; and
lighting up the target sub-pixel to control the light emitted by the display assembly to have the light angle V.

13. The display system according to claim 12, wherein the selecting at least one sub-pixel from the pixel group as a target sub-pixel based on a virtual line comprises:
measuring distances between centers of a plurality of sub-pixels of the pixel group and the virtual line, and selecting at least one sub-pixel whose distance is less than a distance threshold as the target sub-pixel.

14. The display system according to claim 9, wherein the measuring light intensities of a plurality of sites selected on the plane of the eye box under a plurality of different light angles V respectively comprises:
selecting a plurality of sites on the plane of the eye box, wherein the plurality of sites are located on a same virtual straight line, and the virtual straight line is parallel to the first direction.

15. The display system according to claim 14, wherein an interval between two adjacent sites E of the plurality of sites is d, where 20 μm≤d≤40 μm.

16. The display system according to claim 9, wherein the measuring light intensities of a plurality of sites selected on the plane of the eye box under a plurality of different light angles V respectively comprises:
selecting M sites on the plane of the eye box, where W₀/(40 μm)≤M−1≤1.5*W₀/(20 μm), and M is an integer.

17. The display system according to claim 9, wherein the measuring light intensities of a plurality of sites selected on the plane of the eye box under a plurality of different light angles V respectively comprises:
measuring light intensities of a plurality of sites selected on the plane of the eye box under N different light angles V respectively, where Nis an integer, and N≥15.

18. A vehicle comprising a display system,
wherein the display system comprises:
a display assembly, wherein the display assembly comprises a display panel and a prism assembly, the prism assembly is located on a light-emitting side of the display panel, and the prism assembly comprises a plurality of prisms;
a main visual area; and
an eye box,
wherein in a first direction of a plane of the eye box, a width of the main visual area is W, and a width of the eye box is W₀, where W₀≤W≤1.5*W₀.

19. A method for measuring a width of a main visual area of a display system, wherein the display system comprises a display assembly and an eye box, wherein the display assembly comprises a display panel and a prism assembly, the prism assembly is located on a light-emitting side of the display panel, and the prism assembly comprises a plurality of prisms,
the method comprises:
measuring light intensities of a plurality of sites selected on the plane of the eye box under a plurality of different light angles V respectively, wherein one light angle V corresponds to a group of parallel light emitted by the display assembly in a first plane, and the first plane is perpendicular to an axial direction of one of the plurality of prisms;
comparing the light intensities of each of the plurality of sites under a plurality of different light angles V, and recording a light angle V corresponding to a maximum light intensity as a greatest intensity angle Vm, wherein one site corresponds to one greatest intensity angle Vm; and
determining the width of the main visual area based on the greatest intensity angles Vm respectively corresponding to the plurality of sites,
wherein in a first direction of a plane of the eye box, a width of the main visual area is W, and a width of the eye box is W₀, where W₀≤W≤1.5*W₀.

20. The method according to claim 19, wherein the measuring light intensities of a plurality of sites selected on the plane of the eye box under a plurality of different light angles V respectively comprises:
controlling the light emitted by the display assembly to have a light angle V in the first plane, and photographing a virtual image at the plurality of sites selected on the plane of the eye box to obtain light intensities at the plurality of sites, or
selecting a plurality of sites on the plane of the eye box, wherein the plurality of sites are located on a same virtual straight line, and the virtual straight line is parallel to the first direction, or
selecting M sites on the plane of the eye box, where W₀/(40 μm)≤M−1≤1.5*W₀/(20 μm), and M is an integer.
